(19) United States
(12) Patent Application Publication
(10) Pub. No.: US 2008/0159403 A1
(43) Pub. Date: Jul. 3, 2008

(54) System for Use of Complexity of Audio, Image and Video as Perceived by a Human Observer

(76) Inventor: Ted Emerson Dunning, San Diego, CA (US)

Correspondence Address: BRINKS HOFER GILSON & LIONE, P.O. BOX 10395, CHICAGO, IL, 60610, US

(21) Appl. No.: 11/956,896

(22) Filed: Dec. 14, 2007

Related U.S. Application Data
(60) Provisional application No. 60/875,331, filed on Dec. 14, 2006.

(51) Int. Cl. H04B 1/66; H04L 9/00

(52) U.S. Cl. 375/240.21; 713/176

(57) ABSTRACT

A system and method for determining and using complexity of image, audio, or video information as perceived by a human observer is provided. The system and method may determine complexity of the image, audio or video information by using a perceptual model, such as a lossy compression system. The compression system may remove portions of the information (and reduce the size of the information) in ways nearly imperceptible to a human, while preserving the overall human perception. The size of the information after the compression may provide an indicator of the complexity, such as provide an upper bound on the complexity of the information as perceived by a human. The complexity of the information, once determined, may be used in a variety of ways, such as characterizing the information (including fingerprinting the information), comparing the information with other image, audio or video information, or presenting the information.

### CROSS-REFERENCE TO RELATED APPLICATION

This application claims the benefit of U.S. Provisional Application No. 60/875,331, filed Dec. 14, 2006, the entirety of which is hereby incorporated by reference.

### BACKGROUND

Prior systems have compared video signals in order to determine whether one signal is the same as another. This is typically done by representing the video signals in the form of digitally encoded frames and then extracting a variety of heuristically motivated features from the signals. These features are then compared using a variety of heuristic similarity metrics to produce an estimate of the likelihood that two signals are the same. When a part of one video might be included as part of another, a common solution is to extract features from many sub-segments of the videos and to make multiple comparisons of feature sequences for each segment compared to every other segment. The number of comparisons can be very large in such systems commonly leading to poor performance.

The features used might be the raster representations of the frames themselves, or a histogram of the colors of the pixels in an image or even an average brightness of the entire frame. Comparisons between feature values was often performed with a variation on Euclidean distance metric such as mean squared luminance difference for rasterized comparison between frames.

These prior systems were difficult to construct because many heuristic features must normally be combined to obtain a single similarity measure. The use of many heuristic features makes the comparison of many video segments difficult due to problems with the comparison of high dimensional datasets. The use of only a few features is problematic since high recognition accuracy is difficult to achieve with only a few features. Another difficulty is that alternative compressed encodings of the videos would often not preserve the values of these heuristic features, thus defeating the comparisons.

An alternative approach is to embed a secondary signal known as a watermark into the videos. Ideally, the watermark would not be visible to a viewer of the video signal, but would allow an identifier to be extracted from the video that could be extracted from videos in order to recover the information originally embedded in the watermark. For watermarked videos, it is easy to determine whether two videos are versions of the same video since the watermarks can simply be extracted and compared. Moreover, since the information encoded in the watermark is a short string of digitally encoded symbols, there are many efficient forms of searching a table of known watermarks. One way of inserting of the watermark is to embed a highly redundant representation of the watermark in the least significant bits of the pixels in the image.

Unfortunately, if a watermark really does not cause any visible artifacts in the video signal, it is easy for the watermark to be removed by a lossy compression algorithm. This happens because lossy compression algorithms generally only store a modified representation of the original video signal which is imperceptibly different to a human observer, but which can be represented much more concisely than the original signal. This conversion to an alternative concise form can involve any changes to the image that are not obvious to a human observer and often involve forms of smoothing of the signals that can accidentally remove any watermarks. Even worse, if the method for inserting the watermark is widely known, it is often relatively easy to intentionally corrupt the watermark, thus defeating the purpose of the watermark. Watermarks which do not corrupt the image, are robust to compression and which are difficult to remove intentionally have proven very difficult to develop.

Neither of these approaches has been widely adopted due to various difficulties. The comparison of extracted features has typically been computationally very expensive and the features have not been very robust with respect to common corruptions of images. Watermarking has been difficult to use because many watermarks are either easily removed, or cause noticeable corruption of the image being watermarked. Even worse, watermarking is only useful for material that has not yet been released. What is needed is a system that avoids the difficulties of either approach such as costly searching using features that are changed by differing encodings or the prior insertion of a watermark.

### SUMMARY OF THE INVENTION

The present invention comprises a system and method for determining complexity of image, audio, or video information (collectively termed “information”) as perceived by a human observer. The complexity of the information may be used to characterize the information, such as generating a signature of the information for later comparison with other information.

The system and method may use a perceptual model to determine the complexity of the information. The perceptual model may transform or change the information to produce an alternative or more concise version of the information. The difference between the original and the alternative version can be arranged to be nearly imperceptible or less perceptible to a human, while maintaining or substantially maintaining portions of the information as perceived by the viewer. In this manner, the perceptual model may replicate the way a human perceives the information, and characteristics of the alternative version (such as the size of the alternative version) can provide an indicator of perceptual complexity (such as in a manner analogous to the way that a lossless compressor provides a bound on the Shannon entropy of data).

One example of the use of a perceptual model is in lossy compression systems. Compression systems may remove or alter portions of the information in ways nearly imperceptible or less perceptible to a human, while preserving the overall human perception. Specifically, compression systems have used models of human perceptual processes so that compressed representations of audio or video signals can be constructed that differ little (according to a human observer) from the original but which are much more concisely represented. These systems are commonly used in such consumer appliances as DVD players or hand-held video cameras. In this way, compressors may reduce the size of the information, for easier storage and transmission of the information while retaining the human perceptible content.

Unlike previous uses, the compression system (including the output of the compression system) may be used to compute or generate an indicator of complexity of the information being compressed as opposed to creating a compressed version of the original. For example, the size of the information, after the compression, may provide an indicator of the complexity, such as an upper bound on the complexity of the information as perceived by a human. For instance, a first image whose output from the perceptual model is a larger size that a second image's output may be considered more complex to a hum an and include more information content perceptible to a human.

The compression system may also be adjusted to allow for larger differences than would normally be used in a compression system intended for reproducing information for presentation back to humans. The compression system may still attempt to find the smallest alternative form that is similar to the original, but the degree of difference allowable may be increased by only requiring that the gross content of the information be retained.

The complexity of the image, audio, or video information, as perceived by a human, may be used as a reliable or consistent way to characterize the information. Image, audio, or video information may often be subject to changes. As one example, image information may be color-corrected or the like, which changes the value of the information (such as the pixel values in the image). As another example, the information may be rescaled to a different resolution (for images or video) or resampled to a different sampling rate (for audio information). As still another example, the information may be encoded at different bit-rates with different lossy encoders. However, these changes do not typically alter a human's perception of the information significantly. Because the human's perception, especially at the gross level of detail, may be unchanged, the perceptual complexity of the information may likewise not be changed. Thus, using complexity of the image, audio, or video information as perceived by a human enables a consistent way to characterize the information. In addition, the perceptual model may extract a low-dimensional feature quickly, and may be inherently robust to corruption.

One way to characterize the information is for the perceptual model to generate a fingerprint of all or part of the information based on the human perception to the information. For example, the perceptual model may analyze each frame of a video (and all of the information within each frame) to generate the fingerprint of the video. As another example, less than all of the video, such as less than all of the frames (e.g., analyzing differences between every n frames for some small value of n) or less than all of the information within each frame (such as a 2-dimensional subpart of the video near the center of the screen), may be used to generate the fingerprint of the video. With regard to audio, the perceptual model may analyze all the frequencies to generate the fingerprint. Or, only a portion of the audio, such as sounds from a particular frequency or range of frequencies, may be used to generate the fingerprint.

This fingerprint may provide a useful signature of the content of an image, audio, or video, even if the image, audio, or video is modified in a way so as not to substantially change the human perception, such as by different encoding, letterboxing, splicing or other changes. That is, the fingerprint is relatively immune to changes that do not substantially affect human perception. Similar fingerprints may be generated for audio information with similar properties of invariance over changes to the information that preserve the human perception of the information.

The fingerprint, as an indicator of the complexity of the image, audio, or video information, may be used in several ways. First, the fingerprint may be used to make conclusions about the information (such as make a conclusion about the information relative to another image, audio, or video information or make a conclusion about the information itself). For example, the fingerprint of the information may be compared with one or more fingerprints generated from another image, audio or video information (such as a previously identified or known video or an unknown video) to conclude whether the compared information is similar to one another. The one or more fingerprints may be stored in a database and may comprise the fingerprints of known information (such as known images, audios, or videos). In the event that image, audio or video is unknown or unidentified, the fingerprint associated with the image, audio, or video may be compared with fingerprints of known information in order to identify the unknown information.

As another example, the fingerprint (or other complexity information) of a part of the information may be compared with the fingerprint of another part of the information. Specifically, the perceptual model may generate the complexity of a video frame by frame (such as numerically determining the complexity of each frame in a video). The complexity of the frames in the video may then be compared with one another to select the single frame that has more complexity than other images (or the most complexity of all images) in the video. This single image with the most complexity may be the frame chosen as the best thumbnail for a video. Or, the perceptual model may generate the complexity of a plurality of frames (such as various scenes) within a video. In this way, the scene with the most complexity may be the scene chosen as the best scene for a video.

As still another example, the perceptual model may be used to reverse engineer video edits. The perceptual complexity of each image in a video may be arranged as a function of time and may be used in order to compare the video with other information, such as a video of known origin. This may also be beneficial in analyzing two videos. Specifically, when generating a video, the video is typically created (shot in a series of scenes), edited, and then broadcast. Frequently, one may wish to generate a better version of the video using the original scenes shot. However, this may be difficult if the edit decision list describing which scenes were used to edit the video is lost. Fingerprinting using the perceptual complexity may be used to “reverse edit” thereby generating the edit decision list or the sequence of scenes. Specifically, fingerprints of various scenes of the broadcast version may be compared with the fingerprints of the original scenes shot. The comparison may determine which of the broadcast scenes correspond with the originally shot scenes, thus generating the edit decision list. The originally shot scenes may then be used to generate a higher quality broadcast version. Thus, the perceptual model may allow accurate comparisons at low computational cost.

Second, the fingerprint may be used when presenting or rendering the information to a user. For example, when presenting the information to the user, portions of the information that have high human perceived complexity may be treated differently than portions of information that have low human perceived complexity. In particular, one part of an image may be weighted more heavily than another part of an image based on the relative importance of the parts of the images as perceived by the user. Or, one part of an image with a low human perceived complexity may initially be centered and magnified, after which another part of the image with a high human perception may be centered and magnified.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The drawings are not necessarily to scale, emphasis instead being placed upon illustrating the principles of the invention. Moreover, in the figures, like referenced numerals designate corresponding parts throughout the different views.

FIG. 1 is a block diagram illustrating a general structure of measurement of perceptual complexity of information from a signal source.

FIG. 2 is a block diagram illustrating measurement of perceptual complexity of single images.

FIG. 3a is an example of a first image resulting from JPEG compression.

FIG. 3b is an example of the first image in FIG. 3a resulting from low-pass filtering and JPEG compression.

FIG. 3c is an example of a second image resulting from JPEG compression.

FIG. 3d is an example of the second image in FIG. 3c resulting from low-pass filtering and JPEG compression.

FIG. 4 is a block diagram illustrating measurement of perceptual complexity frame by frame for video.

FIG. 5 is a table showing sizes in bytes for compressed individual frames of a video.

FIG. 6 is a block diagram illustrating using frame by frame perceptual complexity signatures for video retrieval.

FIG. 7 is a block diagram illustrating measurement of perceptual complexity of changes between frames for video.

FIG. 8 is a block diagram illustrating measurement of perceptual complexity of an image subdivided into sub-regions.

FIG. 9 is an example of perceptual complexity for sub-regions in an image.

FIG. 10 is a block diagram illustrating measurement of perceptual complexity of audio using a first type of audio compression.

FIG. 11 is a block diagram illustrating measurement of perceptual complexity of audio using a second type of audio compression.

FIG. 12 is a graph of frame by frame perceptual complexity values for two videos.

### DETAILED DESCRIPTION OF THE INVENTION

By way of overview, the preferred embodiments described below relate to determining complexity of audio, visual, and/or video information as perceived by a human, and applications of the determined complexity. One type of measurement is perceptual complexity, which quantifies the degree of interesting complexity contained in an image, audio, or video signal as perceived by a human observer. Thus, instead of focusing on axiomatic derivation, such as Shannon entropy or Kolmogorov complexity, perceptual complexity may use models of human perception to extract a measure that represents the complexity that is perceived by a human observer. This measure may be widely useful in a variety of applications, as described in more detail below.

Finding a measure that corresponds satisfactorily with human intuitions and perceptions of complexity is a difficult and long-standing problem. Most approaches have primarily made use of mathematical argument starting from axiomatic descriptions of order in terms either of probability theory or the theory of computation. These approaches, however, neglect the human perceptual aspect of the problem.

Perceptual complexity, in contrast, uses models of human perception of the audio, image, or video information in order to determine the complexity as perceived by a human observer. As discussed in more detail below, the model may use compression algorithms (such as lossy compression algorithms) that are typically used to reproduce the information. Specifically, lossy compression algorithms have used models of human perception to determine what errors might be acceptable in reproducing an image, video, or audio signal. By introducing errors that are small in a perceptual sense, the input signal may be compressed to a much greater degree than is possible without introducing these errors. A perceptual model in such a compression system may make use of idealized images or sound in general (as perceived by a human) and the errors are introduced to make the image or sound be expressed as a simpler combination of ideals. The result may not be a universal measure of complexity as is the goal with Shannon entropy or Kolmogorov algorithmic complexity, but rather a measure that is specific to human perceptual processes. The use of a lossy compressor may be analogous to the use of a lossless algorithmic compressor in Kolmogorov complexity, but the introduction of lossiness and a perceptual model may change the results dramatically.

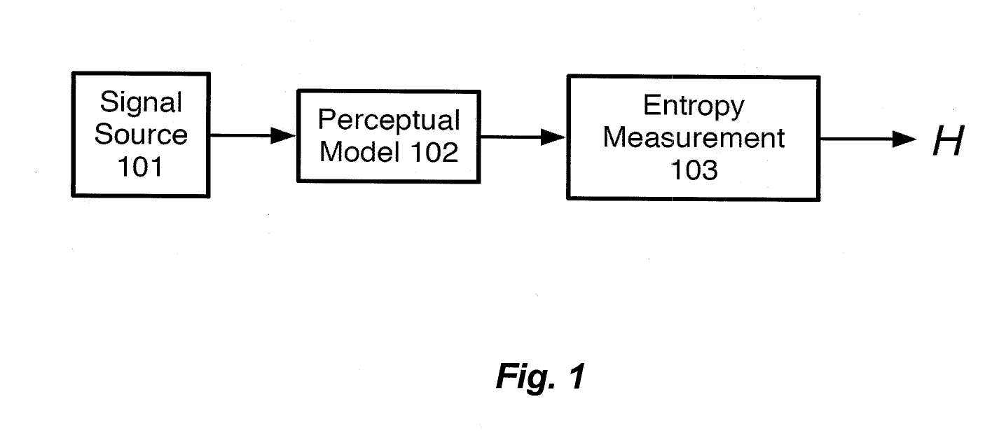

FIG. 1 shows the general structure of a mechanism for measuring perceptual complexity. A signal source 101 may provide a representation of a signal. The signal may be an image signal, an audio signal, a video signal, or any other input that might ultimately be perceived by a human observer. This representation may be passed to a perceptual model 102 that models the way that a human would perceive the signal. The perceptual model 102 may be resident in a computer, with methodologies of the perceptual model 102 resident in a memory (such as volatile and/or non-volatile memory) and with execution of the methodologies being performed by a processor (such as a single microprocessor or multiple microprocessors) in the computer. The computer may comprise a single, standalone computer, or may comprise a series of computers. Further, the computer may comprise a server accessible via an intranet or the Internet. The signal source 101 may be stored in the memory of the computer or may be input to the computer for processing by the perceptual model 102. For example, the signal source 101 may be input via an input device connected to the computer, such as a USB drive, or via a database in communication with the computer. As another example, the signal source 101 may be input via a separate computer that may communicate (such as via an intranet or Internet) with and send the signal source 101 to the computer (or server) that executes the perceptual model 102.

The perceptual model 102 modifies the signal source 101 such that signals that a human would not easily distinguish may be reduced to very similar representations, while signals that are perceptually distinct are not so confounded. As discussed below, one example of a perceptual model 102 may comprise processes similar to (or identical to) compression. The perceptual model may provide an output that is measurable of the information content of the signal source 101.

As shown in FIG. 1, the measurement of the perceptual complexity is performed by entropy measurement 103. The measurement of the perceptual complexity may comprise analyzing at least one aspect of the output of the model. The one aspect may comprise the size of a compressed representation (if a compression methodology is use). The one aspect of the output may also comprise a statistical analysis of the output of the perceptual model 102. The results of the entropy measurement 103 are represented as H. As discussed in more detail below, H may be used in a variety of ways, including characterizing the source signal 101, comparing different information (either known or unknown) with the source signal, or presenting the source signal 101 (or a transformation of the source signal 101) to a human. When the entropy is made in a way that varies over time, such as with video or audio information, the entropy at a point in time is represented as H(t).

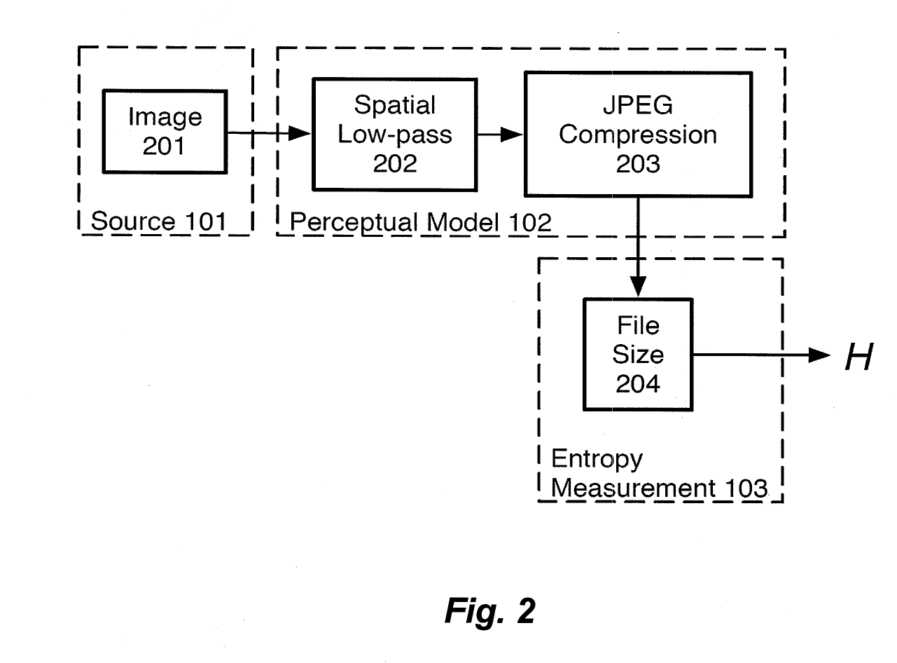

FIG. 2 is a block diagram illustrating measurement of perceptual complexity of single images. A single image 201 may constitute the input signal source 101 while the perceptual model 102 may comprise one of or both of a spatial low-pass filter 202 and a JPEG compression algorithm 203. The JPEG compression algorithm 203 is one type of compression algorithm for images, such as photographic images. The JPEG compression algorithm encodes images using a variety of techniques, such as color space transformation, downsampling, discrete cosine transforms, quantization, etc.

The encoding techniques, such as quantization, of the JPEG compression algorithm 203 may compress the image while maintaining, or substantially maintaining, the portions of the image that a human may perceptually distinguish. Specifically, the human visual system is not good at seeing small, slow changes in brightness over a relatively large area, but may be very good at discerning when adjacent large areas have a sharp change in brightness. The human visual system may also not be able to discern the exact structure of large amounts of fine structure such as might be seen in the different lengths and orientations of each blade of grass in field. Large areas of consistent orientation of, say blades of grass, is however, highly apparent. Moreover, the gross details of an image can be encoded using a representation that has only low spatial frequencies or by reducing the image to a cartoon like representation. The JPEG algorithm is a lossy image compressor that that emphasizes lower spatial frequencies in order to reproduce images that are appear similar to the original to a human observer, but which can be represented very concisely. When only gross levels of detail are desired, a spatial low pass filter (which produces a blurring of the original image) can be used before the JPEG compression to further suppress fine levels of detail.

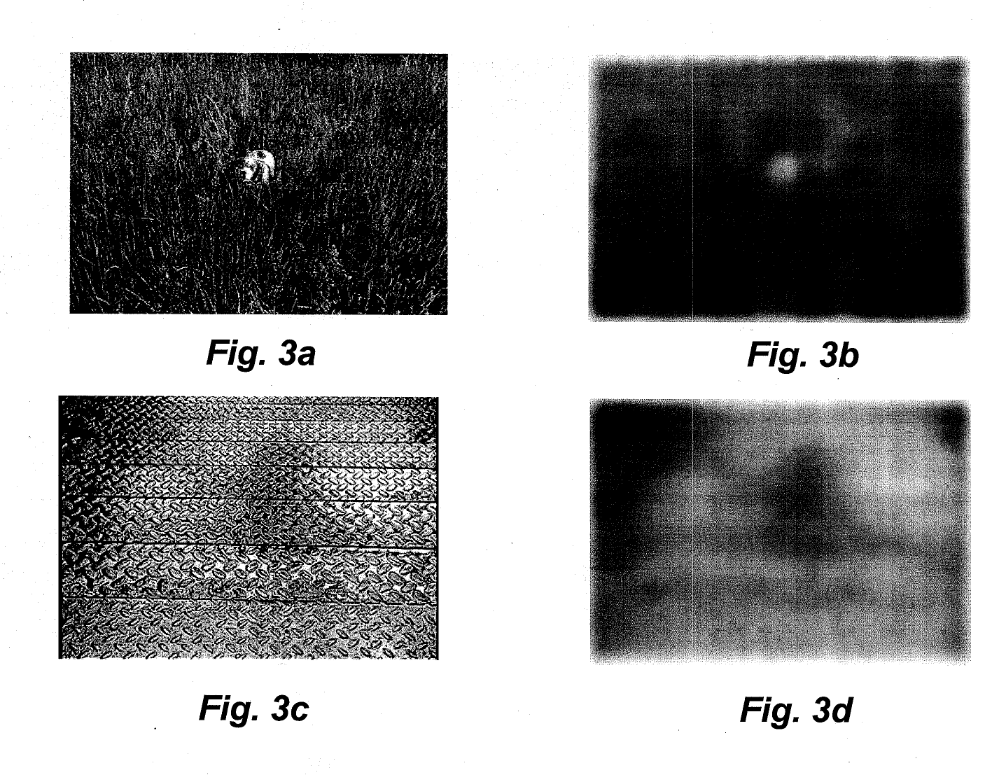

FIGS. 3a-d are examples of images that JPEG may not compress well, but which have low perceptual complexity at a gross level of detail. For example, in the image in FIG. 3a, the positions and shapes of the individual blades of grass may not be important to the human observer. The dog, shown in the center of the image in FIG. 3a, including the general color and textural properties of it, may be important to the human observer. FIG. 3b shows the first image depicted in FIG. 3a, with both low pass filtering and JPEG compression. As shown in FIG. 3b, only general details remain. FIG. 3c shows an image after JPEG compression of a person's reflection in a set of stairs. The general statistical properties of the image in FIG. 3c are discernible to the viewer, but the details are generally not so discernible (e.g., the detailed patterning on the stairs does not contribute to the perceptual complexity). FIG. 3d shows the image depicted in FIG. 3c, with both low pass filtering and JPEG compression, in which the person's reflection is more apparent than the texture of the stairs.

JPEG is one example of a compression algorithm. JPEG may reduce the size of the image file by removing details in the image. One example is removing a mass of detail in the image that a human observer may not interpret except in general terms. Other methodologies may be used for the perceptual model 102 to transform the signal source 101. Thus, it is possible to compress the images shown in FIG. 3 much more than JPEG does by using more advanced compression algorithms that encode repetitive patterns or general texture. When the goal is to simply compute an approximation to perceptual complexity of gross details, it may be, however, possible to use a much simpler perceptual model and compression system.

The perceptual model 102 may further comprise a filter, such as spatial low pass filter 202. The filter may provide an improved perceptual complexity measurement at a gross level of detail, since it will soften small-scale detail and allowing images with large amounts of very fine detail to be compressed very highly. In addition to a filter (or instead of a filter), the perceptual model may search for areas in an image that may be approximated using textural approximations or by repeated stenciling. For example, fractal image compression techniques may be used. For simplicity and computational efficiency, a low pass filter may be used.

The perceptual model 102 may further comprise other normalization operations performed prior to compression such as converting the audio or visual information to a standardized format or condition with standardized resolution, sample rate or frame rate. Standardization of video resolution may be used to allow a single parameter setting for the low-pass spatial filter or to decrease computational resource requirements. Standardization of audio sample rate or video frame rate may be used to ensure that all fingerprints extracted will be directly comparable without time scaling. For video signals, removal of letterboxing and extraction of the central part of the frames may also be done. Other normalization operations may be employed as well.

As discussed in more detail below, perceptual complexity may be used in several applications, including in a machine learning system or an image retrieval system. Perceptual complexity may provide a feature that is relatively insensitive to changes that do not affect how a human observer would see an image.

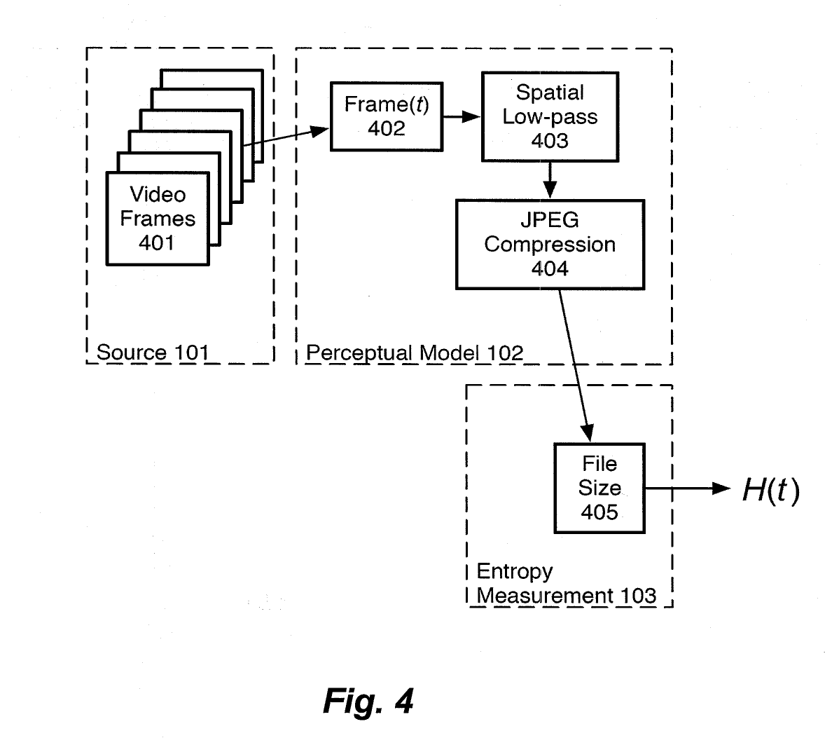

FIG. 4 is a block diagram illustrating another measurement of perceptual complexity frame by frame for video. Multiple frames (including potentially all frames) of a video 401 are examined one frame 402 at a time. The perceptual complexity of each frame is determined using a spatial low-pass filter 403, and compression step 404, similar to the spatial low pass filter 202 and compression 203 discussed in FIG. 2.

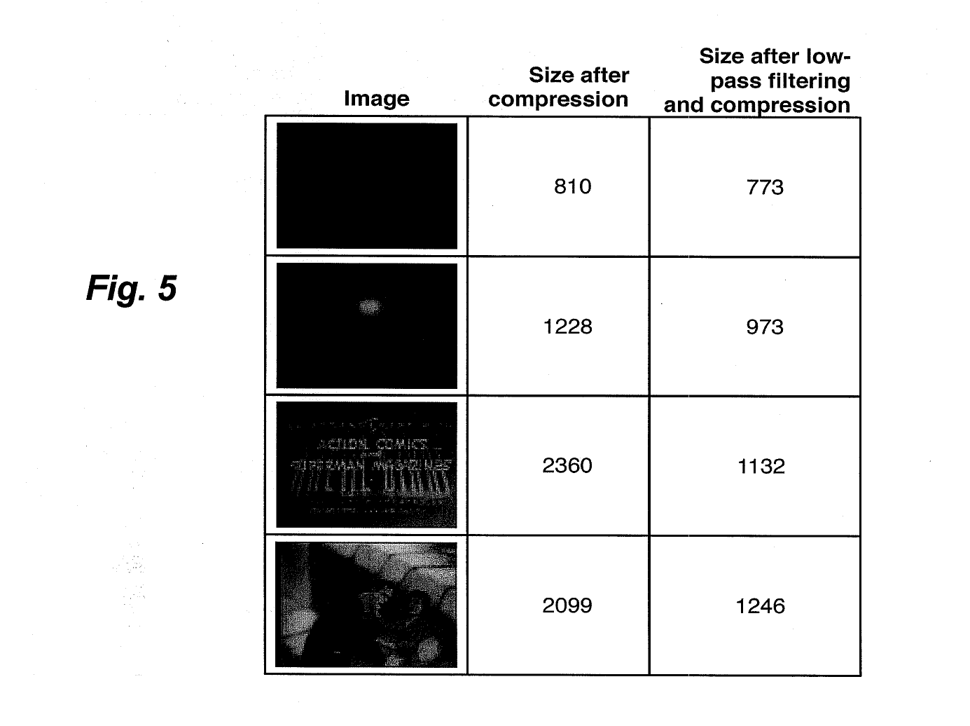

The entropy measurement 103 may comprise analysis of the compressed image size 405 as output by the perceptual model 102. Taking the image with the largest perceptual complexity may be useful to select a good thumbnail image for the entire video. As an example, FIG. 5 is a table showing sizes in bytes for compressed individual frames of a video. The second and third columns in FIG. 5 show the size in bytes of the frame after raw JPEG compression and after low-pass filtering and JPEG compression. Both measures may be an approximation of perceptual complexity; however, the right hand column may be a better estimate of the complexity at a gross level of detail. Completely featureless frames such as the first frame in FIG. 5 have very low perceptual complexity. Frames with simple contents as in the second row also have relatively low perceptual complexity. Simple compression with JPEG shows a larger decrease in size compared to compression after low-pass filtering due to the fine lines in the image. The third row has relatively large raw JPEG size, but the filtered compressed size shows that this is an artifact of the way that the image is a blend of two images that occurs due to a fade from one image to another. The last row has the highest perceptual complexity of the frames shown in FIG. 5. The low-pass filtered approximation may choose this image as having the highest complexity, so that this frame may be chosen as the best thumbnail for frames shown in FIG. 5 or the best thumbnail for the entire video if all of the frames are analyzed.

As an alternative to taking the frame with the highest individual entropy, a system may use the perceptual complexity of all of the potential thumbnail images with and without spatial filtering as well as the ratios for each potential thumbnail between the unfiltered and filtered estimates of perceptual complexity. Images with very large ratios may not be good thumbnails and images with very high perceptual complexity that are much higher than the rest of the images from a video may also not be good thumbnail images. One, some, or all of these considerations may be combined using machine learning techniques along with feedback from human judges to build a composite system for selecting thumbnail images.

As an alternative to selecting individual frames with the highest or higher individual entropy, the complexity of short sequences of video frames (such as a predetermined number of frames or a predetermined time of video play) may be estimated. For example, the short sequences of video frames may be compressed, analogously to the way that individual frames were compressed; however, when compressing the short sequences, frame-to-frame information may be used. For example, the short sequences of video frames may be analyzed to determine whether the individual frames in the short sequence include high complexity (such as higher complexity relative to other short sequences in the video). As another example, the short sequences of video frames may be analyzed to determine whether the frames within the short sequence have a particular variation of complexity (such as certain frames having high complexity and other frames having low complexity). This analysis may be used to select a short segment from a video that has high complexity (or certain complexity characteristics) and thus is likely to be of most interest to a human viewer. The video sequence may be constrained not to cross the boundaries between scenes. For example, by using motion tracking (whereby certain items in a video are tracked from one frame to the next), the scene boundary may be determined. The video sequence may be selected such that it is constrained to a particular scene. Whether a single frame (or thumbnail) is selected or a short video segment is selected, the basic structure of the system is the same.

The perceptual complexity of each image in a video may be arranged as a function of time and may be used in order to compare the video with other information, such as a video of known or unknown origin. For example, perceptual complexity may be used to facilitate the retrieval of videos from a database of other videos for the purpose of duplicate detection. This may be beneficial, for example, if a copyright owner of a video has indicated that distribution of the video is not to be allowed. As another example, this may also be beneficial in analyzing two videos. Specifically, when generating a video, the video is typically created (shot in a series of scenes), edited, and then broadcast. Frequently, one may wish to generate a better version of the video using the original scenes shot. However, this may be difficult if the edit decision list describing which scenes were used to edit the video is lost. Fingerprinting using the perceptual complexity may be used to “reverse edit” thereby generating the edit decision list. Specifically, fingerprints of various scenes of the broadcast version may be compared with the fingerprints of the original scenes shot. The comparison may determine which of the broadcast scenes correspond with the originally shot scenes, thus generating the edit decision list. The originally shot scenes may then be used to generate a higher quality broadcast version.

One example of processing perceptual entropy from video data is by dot-plot projection. The dot plot projection may comprise: (1) n-gram extraction and indexing; (2) querying n-gram extraction; (3) positional scoring (such as by square root weighting); and (4) spike filtering and score vector decimation. Using dot-plot projection may find at least some alternative encodings of videos from collections that may contain thousands of videos. Other methods, in addition to dot-plot projection, may include early decimation of the score vector, unfiltered score vectors, simple low filtering of the results, and inverse log frequency weighting of n-grams.

In the application using dot-plot projection, a database may be used composes of quantized perceptual entropy samples of tens of thousands of videos that were known to contain the single query video and two additional copies of the video. The copies may be originally published using different levels of compression and may have edited slightly differently from one another. To facilitate magnified view of the data, fingerprints for some of the videos (such as 7 videos: the query video, four videos from the same publisher, and the 2 copies) may be replicated from the database.

Both the database and the query video may be converted to quantized fingerprints by measuring perceptual entropy of each frame (as described above), down-sampling the perceptual entropy (such as to four frames per second), and quantizing this down-sampled value (such as to six levels using a locally adaptive quantizer with a three second window). For indexing, the quantized fingerprint for each video in the database may be converted to a list of overlapping n-grams (such as 9-grams). An index containing a map from the hash of the n-gram value to a list of positions may be created from this data.

The search of the database may be performed by iterating over the n-grams in the quantized fingerprint of the query video and accumulating scores for each occurrence of the same n-gram in the test database. Scores may be accumulated in a vector with one value for each position in the database. Matches for n-gram x may be given a score based on various weights, such as the following:

w_{log,x}=log N/Nₓ

W_{squareroot,x}=sqrt(N/Nₓ)

w_{linear,x}=N/Nₓ

where N is the total number of n-grams observed and Nₓ is the number of times that n-gram x occurred. Scores may be accumulated in the results vector at a position equal to the difference between the position of the n-gram in the database and the query. Further, if the matching segment starts at the beginning of the video, then the position in the result vector can be used to directly read off the position of the match in the database.

After the scores are accumulated, they may be filtered using a low-pass filter (such as an approximate Gaussian smoothing function and the second derivative of the approximate Gaussian). One may analyze various combinations of weighting versus filtering to determine an acceptable methodology. For example, a square root weighting with the derivative operator may provide acceptable results.

The perceptual complexity of a video as a function of time may provide a useful signature of the content of a video since it is relatively immune to changes in encoding, letterboxing, splicing or other changes that might occur during a possibly illicit distribution process. Once a database of signatures has been compiled for videos that are previously known, a new video's signature may be compared to the signatures of known videos using a retrieval system for real-valued functions. Thus, the signature of a first video (video “A”) of either known or unknown origin may be compared with the database of signatures in order to determine that the signature of the first video is similar to the signature of a second video (video “B”). As a subsequent action, the system may analyze whether there are any signatures in the database that are similar to video “B”. In the event that the system determines that there is a third video (video “C”) that has a signature similar to video “B,” the system may conclude in turn that video “A” is similar to video “C.”

One example of such a retrieval system for the present application is the SAX (Symbolic Aggregate Approximation) system. SAX is a symbolic representation for time series that may allow for dimensionality reduction and indexing with a lower-bounding distance measure. In classic data mining tasks such as clustering, classification, index, etc., SAX may be used, as well as other representations such as Discrete Wavelet Transform (DWT) and Discrete Fourier Transform (DFT). The SAX system may reduce continuous-valued functions of time to symbolic representations (such as letters) that may then be indexed for fast retrieval using standard string manipulation systems. Examples of retrieval systems include the Lucene text retrieval system, and the BLAST system for genetic sequence search.

For example, the BLAST retrieval system may compare a query sequence to all information in a specified database. Comparisons may be made in a pairwise fashion. Each comparison may be given a score reflecting the degree of similarity between the query and the sequence being compared. The higher the score, the greater the degree of similarity. The similarity may be measured and shown by aligning two pieces of information. Alignments can be global or local. A global alignment is an optimal alignment that includes all characters from each piece of information, whereas a local alignment is an optimal alignment that includes only the most similar local region or regions. Discriminating between real and artifactual matches may be done using an estimate of probability that the match might occur by chance. The retrieval may retrieve entire videos or it may find portions of other video information that occur in the query sequence.

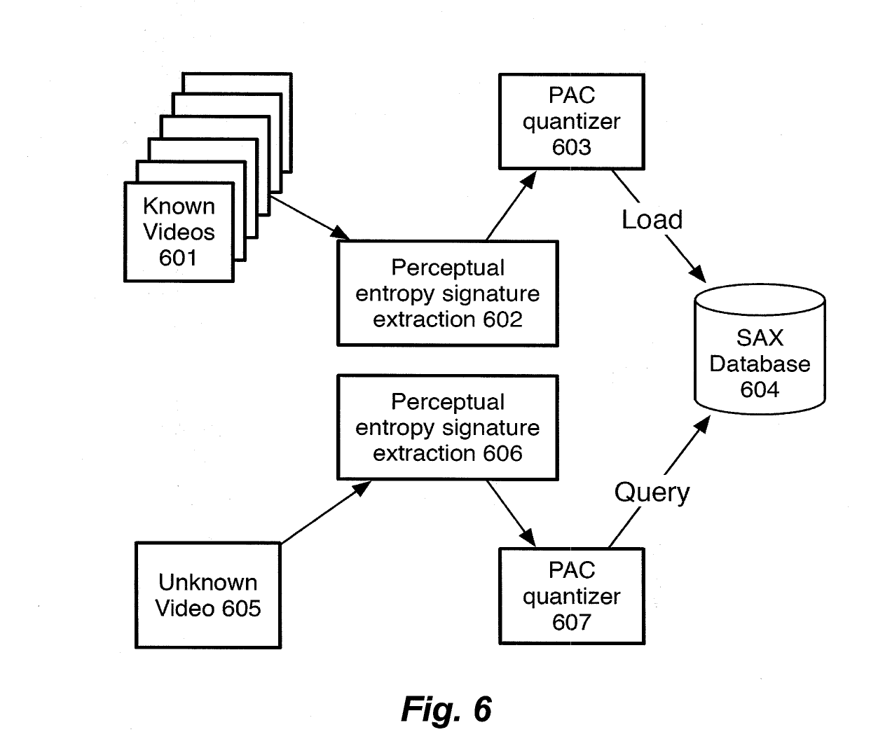

FIG. 6 is a block diagram illustrating using frame by frame perceptual complexity signatures for video retrieval. Known videos 601 may be converted using perceptual complexity signature extraction 602 to perceptual complexity signature form. These signatures may be converted to symbolic sequences for search by a PAC quantizer 603 and entered into a SAX database 604. The process of storing symbolic sequences corresponding to perceptual complexity is known as indexing and may occur before searches are done. At search time, an unknown video 605 may be converted to a signature using perceptual complexity signature extraction 606 that is quantized using PAC quantizer 607 and used to query the SAX database 604 for similar videos.

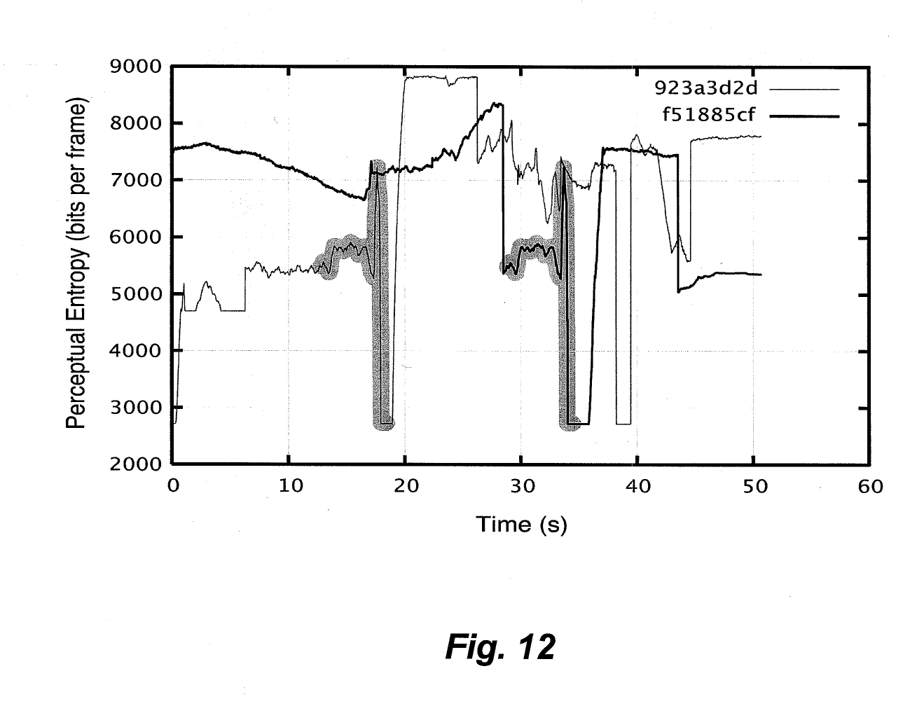

FIG. 12 is a graph of frame by frame perceptual complexity values for two videos that may be generated using the system depicted in FIG. 6. As shown in FIG. 12, the perceptual complexity for two different videos is illustrated over a period of time. Further, as shown in FIG. 12, a common sequence is present in each of the videos, as shown by the portions of the graph highlighted by the grey background. The common sequence is offset in time from one another, occurring approximately 15 seconds from one another. Thus, at least a portion of each of the videos depicted in FIG. 12 may be considered the same based on the determined perceptual complexity.

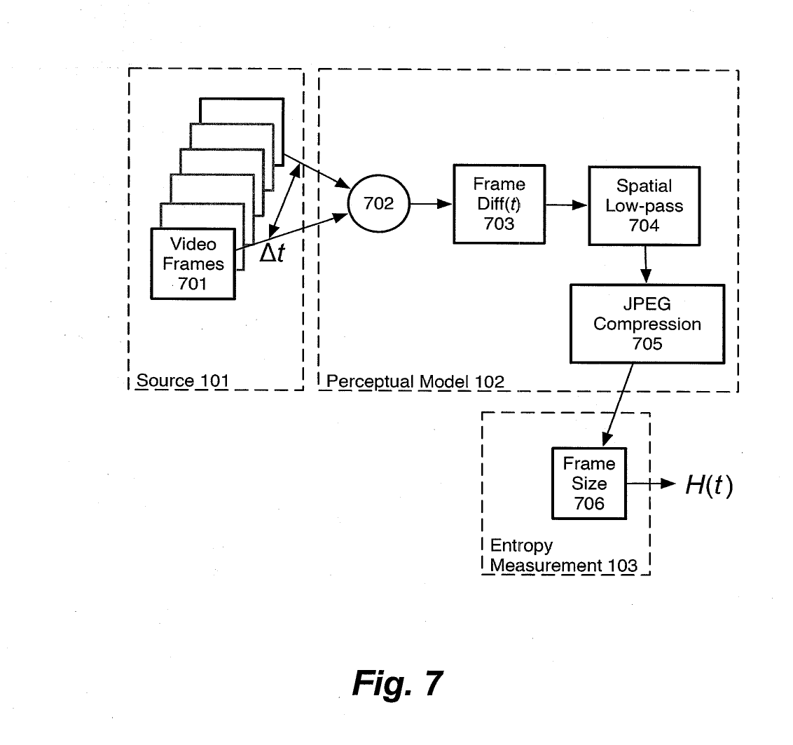

FIG. 7 is a block diagram illustrating measurement of perceptual complexity of changes between frames for video. Specifically, FIG. 7 illustrates an alternative method for extracting perceptual complexity signatures from a video 701. In this system, frames a constant or predetermined distance in time (Δt) apart may be subtracted 702 on a pixel by pixel basis. The result of the subtraction may be an absolute difference, or a signed difference, depending on the needs for a particular application. The frame difference may be determined using Frame Diff(t) 703, may then be low-pass filtered using spatial low-pass filter 704 and may be compressed using JPEG compression 705. As discussed above, other compression algorithms may be used to build the perceptual model component of the system 102. Further, as shown in FIG. 7, the image difference is determined before extracting perceptual complexity. The final extraction of the compressed frame size 706 may be performed analogously to the way that it was performed in FIG. 4.

Frame subtraction and JPEG compression, as illustrated in FIG. 7, may comprise a simple form of an inter-frame compression system. Other, more advanced video codec approaches may be used to compute perceptual complexity with the advantage that the perceptual model involved may make use of temporal models of perception as well as static ones as are done in the JPEG algorithm. Most video codecs may be adapted to output the number of bits used to encode each frame. This number of bits may be used as an approximation of perceptual complexity for the video being compressed. If a codec is adapted in this way, the presence of key frames may be accounted for. Key frames may comprise statically compressed frames inserted into the data stream periodically to facilitate seeking to a particular frame without having to reconstruct all frames between the beginning of the video and the desired frame.

In addition, static and dynamic perceptual complexity may be combined in a 2-dimensional, 3-dimensional, or n-dimensional adaptation of the SAX or other signal retrieval system. SAX may only be usable for 1-dimensional signals. The PAC quantization method used by SAX may be extended to higher dimensional cases, resulting in vector quantization algorithms that have similar lower bounding distance measures.

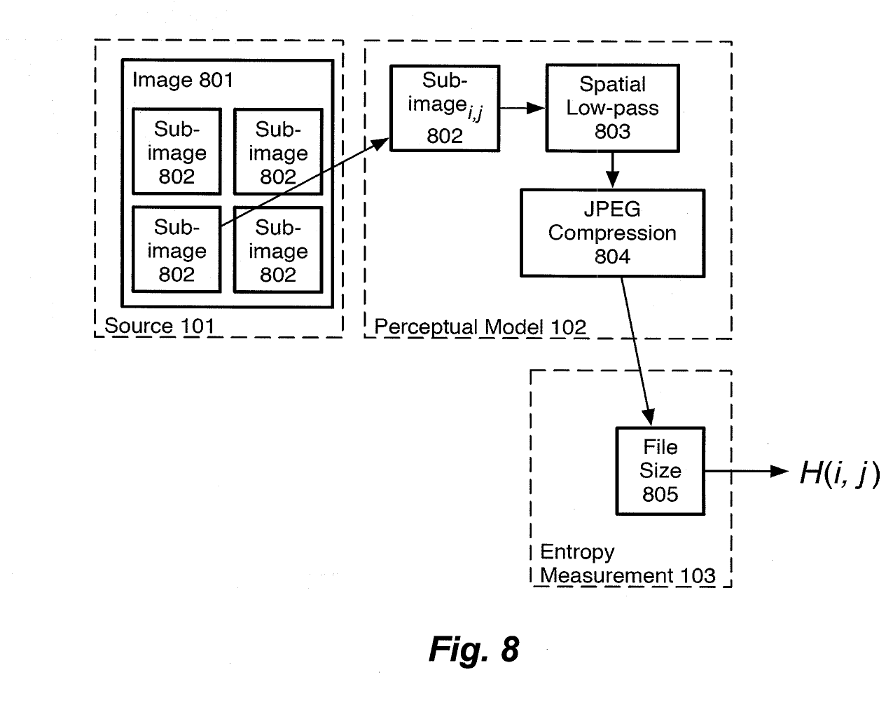

FIG. 8 is a block diagram illustrating measurement of perceptual complexity of an image subdivided into sub-regions. Specifically, FIG. 8 illustrates how perceptual complexity for sub-images of a single static image may be determined. In this system, a static image 801 may be sub-divided into sub-images 802. One, some or all of the sub-images 802 may then be processed with a spatial low-pass filter 803 and compression system, such as JPEG compression 804, in order to allow a file size measurement 805 to derive an estimate of the perceptual complexity of each sub-image. Other alternative methods for estimating perceptual complexity may also be used. In many cases, it may be desirable to have the sub-images 802 to at least partially overlap in extent in the original image.

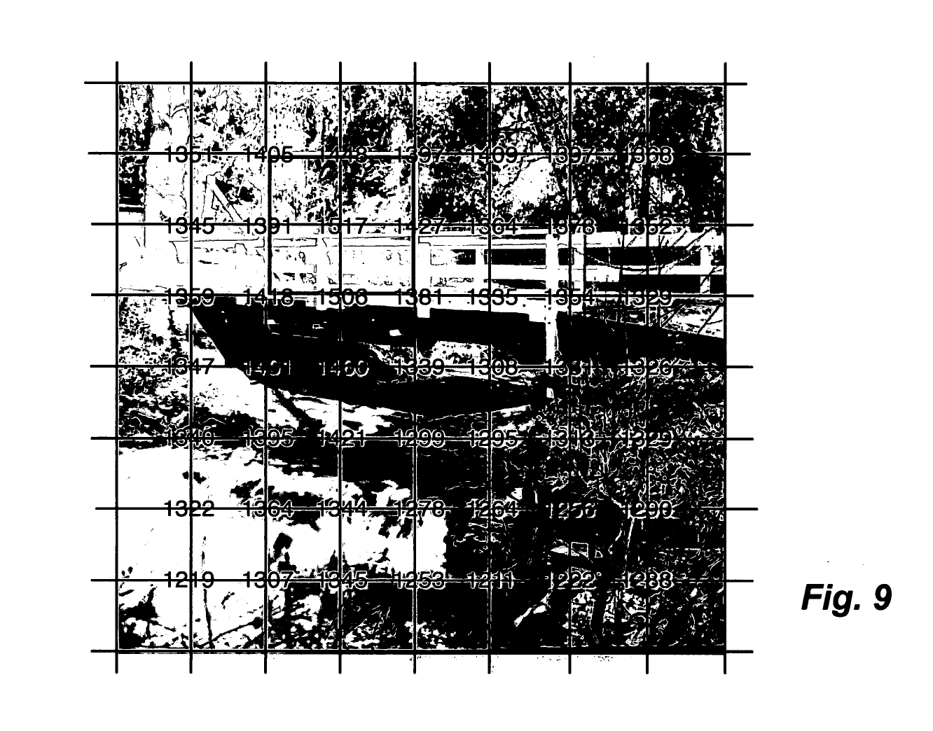

FIG. 9 shows sub-image perceptual entropies for sub-images computed for a standard test image as described above. This image is divided into 64 sub-blocks. Fewer or greater sub-blocks may be used. Each 2×2 group of 4 sub-blocks may then be assembled to form the 49 (7×7) overlapping sub-images. Perceptual entropies are shown in FIG. 9 for each of the sub-images. The visual center of interest in the highly illuminated part of the bridge coincides with the peak in perceptual complexity. The lowest value for perceptual complexity is found in the lower part of the image in an area of dirt and brush.

One application of sub-image perceptual complexity may be to weight features found in different parts of the image more heavily if they are found in regions of high perceptual complexity and lower if they are found in regions of low perceptual complexity. Another application of sub-image perceptual complexity may be in presenting some or all of the image, such as presenting the images in an automated slide show. The original image may initially be magnified and centered in a low entropy region. During the presentation of the image the zoom and position may be modified as the point of view moves to a region of high interest. Likewise, if there are multiple points of high perceptual complexity, the point of view of the slide show may move from one point of interest (as indicated by a local peak in perceptual complexity) to another.

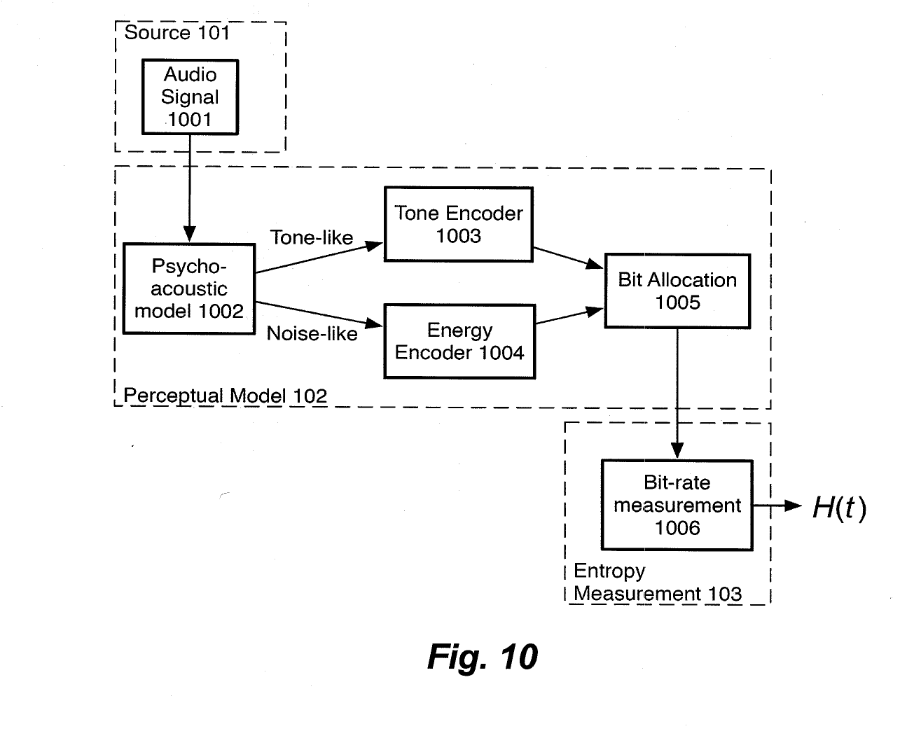

Perceptual complexity may also be approximated for audio sources. The availability of sophisticated psycho-acoustic models intended for audio compression may make allow estimation of perceptual complexity for audio signals. FIG. 10 is a block diagram illustrating measurement of perceptual complexity of audio using a first type of audio compression. Specifically, FIG. 10 illustrates an audio codec such as a QDesign Music Codec (QDMC) that is designed to reproduce sound at high quality using low bit rates. In this class of codec, an audio signal 1001 may be decomposed using psycho-acoustic model 1002 into a number of virtual source components. In FIG. 10, this is indicated by a split between tone-like using a tone encoder 1003 and noise-like using an energy encoder 1004 signals. In a practical codec, the division may be more complex; however, FIG. 10 illustrates the principle of the division of the audio signal 1001. Each of these sources may be encoded separately in a manner most suitable for the particular source. Bits may then be allocated in the output stream using bit allocation 1005 so as to produce the least audible artifacts in the resulting audio stream. When operated in a variable bit rate (constant quality) mode, the code may produce more or less bits of encoded audio per second according to how difficult the input signal is to encode. The output of a codec such as this may then be analyzed using bit-rate measurement 1006 to measure the average bit-rate over a predetermined interval, such as a short time interval. This bit-rate may be an approximation of the perceptual complexity of the audio signal.

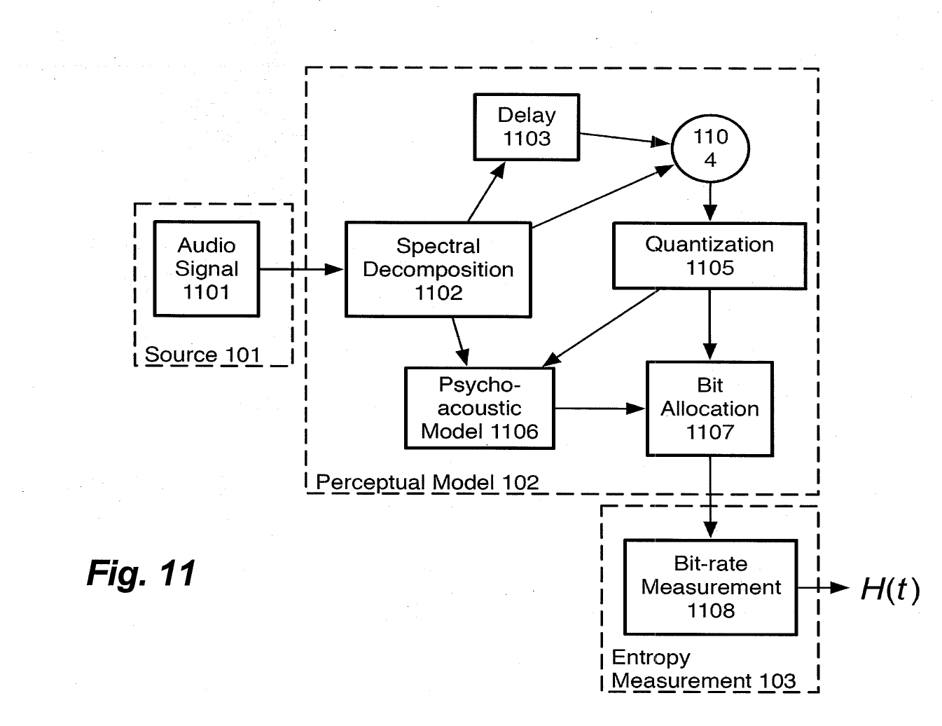

FIG. 10 illustrates one type of audio compression. Other types of audio compression may be used, such as filterbank based audio codecs including MP3 or AAC, which may be very different from the QDMC. FIG. 11 is a block diagram illustrating measurement of perceptual complexity of audio using this second type of audio compression. The audio signal 1101 may be decomposed into a spectral representation by a filter bank or equivalent using spectral decomposition 1102. This spectral representation and short-term changes in the spectral representation may be passed to a psycho-acoustic model 1106 in order to determine which compromises may be made in representation of the spectral representation in order to cause the least audible artifacts in the final encoded output in bit allocation 1107. Regardless of the fact that the filterbank codecs may be operated in a variable bit rate mode, the average number of bits used over short time periods may be measured using bit-rate measurement 1108, much as was indicated in FIG. 10. This average bit-rate may be one example of an approximation of the perceptual complexity of the audio signal.

When computing perceptual complexity of audio information, it may be useful to limit the bandwidth of the audio signal before computing the complexity of the information. This bandpass filtering may be used analogously to the blurring in video complexity computation to focus the complexity on the gross details of the audio information in order to minimize the impact of different encodings and sample rates.

With audio perceptual complexity, measures of long stretches of silence, constant tonal sources or constant noise may each be assigned low levels of entropy. Sudden percussive attacks or shifts in complex chordal structure may be assigned high entropy. The time profile of perceptual complexity may be encoded, such as by using a SAX retrieval system, as was shown in FIG. 6 in order to retrieve audio signals. Further, the time profile of perceptual complexity may be combined with other signals such as total energy, frequency band balance or many other factors for processing audio for retrieval or for building models for extracting information such as tempo, beat or class of music.

While this invention has been particularly shown and described with references to preferred embodiments thereof, it will be understood by those skilled in the art that various changes in form and details may be made therein without departing from the scope of the invention encompassed by the appended claims.

1. A method for characterizing complexity of audio or visual information as perceived by a human, the method comprising:
applying a model of human perception to at least a part of the audio or visual information, the model modifying at least one aspect of the audio or visual information; and
analyzing the aspect modified by the model in order to characterize complexity of the audio or visual information as perceived by the human.

2. The method of claim 1, wherein the model compresses the audio or visual information; and
wherein analyzing the aspect comprises analyzing a size of the audio or visual information after compressing.

3. The method of claim 2, wherein the model is adapted to reduce the size of the audio or visual information by removing information nearly imperceptible to the human; and
wherein the model further low-pass filters the audio or visual information.

4. The method of claim 1, wherein the audio or visual information comprises multiple images in a video; and
wherein the model determines a complexity of at least a part of the multiple images by extracting at least a portion of each of the multiple images in the video.

5. The method of claim 4, wherein the model compresses the audio or visual information; and
further comprising normalizing the multiple images in the video prior to compressing the audio or visual information.

6. The method of claim 4, wherein the model is applied to differences between the multiple images in the video.

7. The method of claim 4, wherein analyzing comprises comparing the complexity of the multiple images to determine a most complex image.

8. The method of claim 4, wherein the video comprises a plurality of scenes, the scenes each comprising multiple frames; and
wherein analyzing comprises comparing the complexity of the multiple scenes by analyzing the multiple frames within the scenes in order to determine a most complex scene from the plurality of scenes in the video.

9. The method of claim 1, wherein analyzing further comprises generating a fingerprint of the audio or visual information based on the complexity.

10. The method of claim 9, further comprising comparing the fingerprint of the audio or visual information with a fingerprint of a known audio or visual information in order to determine whether at least a part of the audio or visual information is substantially the same as at least part of the known audio or visual information.

11. The method of claim 1, wherein the audio or visual information comprises a plurality of video clips;
wherein analyzing comprises generating fingerprints of each of the plurality of video clips; and
further comprising:
comparing the fingerprints of each of the plurality of video clips with at least one fingerprint from one or more known video clips in order to determine a sequence list, the sequence list comprising a listing of a sequence of at least some of the plurality of video clips that comprise the one or more known video clips.

12. A method of determining human perception of audio or visual information, the method comprising:
compressing at least part of the audio or visual information, the compressing adapted to reduce size of the audio or visual information; and
analyzing the size of the compressed audio or visual information in order to determine human perception of the audio or visual information.

13. The method of claim 12, wherein the information comprises video information including multiple images.

14. The method of claim 12, wherein the compression methodology comprises lossy compression.

15. The method of claim 12, wherein analyzing the size determines a degree of complexity of the compressed audio or visual information as perceived by a human observer.

16. A system for characterizing complexity of audio or visual information as perceived by a human, the system comprising logic for:
applying a model of human perception to at least a part of the audio or visual information, the model modifying at least one aspect of the audio or visual information; and
analyzing the aspect modified by the model in order to characterize complexity of the audio or visual information as perceived by the human.

17. The system of claim 16, wherein the model compresses the audio or visual information; and
wherein analyzing the aspect comprises analyzing a size of the audio or visual information after compressing.

18. The system of claim 17, wherein the model is adapted to reduce the size of the audio or visual information by removing information nearly imperceptible to the human; and
wherein the model further low-pass filters the audio or visual information.

19. The system of claim 16, wherein the audio or visual information comprises multiple images in a video; and
wherein the model determines a complexity of at least a part of the multiple images by extracting at least a portion of each of the multiple images in the video.

20. The system of claim 19, wherein the model compresses the audio or visual information; and
further comprising normalizing the multiple images in the video prior to compressing the audio or visual information.

21. The system of claim 19, wherein the model is applied to differences between the multiple images in the video.

22. The system of claim 19, wherein analyzing comprises comparing the complexity of the multiple images to determine a most complex image.

23. The system of claim 19, wherein the video comprises a plurality of scenes, the scenes each comprising multiple frames; and
wherein analyzing comprises comparing the complexity of the multiple scenes by analyzing the multiple frames within the scenes in order to determine a most complex scene from the plurality of scenes in the video.

24. The system of claim 16, wherein analyzing further comprises generating a fingerprint of the audio or visual information based on the complexity.

25. The system of claim 24, further comprising comparing the fingerprint of the audio or visual information with a fingerprint of a known audio or visual information in order to determine whether at least a part of the audio or visual information is substantially the same as at least part of the known audio or visual information.

26. The system of claim 19, wherein the audio or visual information comprises a plurality of video clips;
wherein analyzing comprises generating fingerprints of each of the plurality of video clips; and
further comprising:
comparing the fingerprints of each of the plurality of video clips with at least one fingerprint from one or more known video clips in order to determine a sequence list, the sequence list comprising a listing of a sequence of at least some of the plurality of video clips that comprise the one or more known video clips.
